(19) United States
(12) Patent Application Publication
(10) Pub. No.: US 2009/0046806 A1
(43) Pub. Date: Feb. 19, 2009

(54) WIRELESS COMMUNICATION METHOD IN MULTIANTENNA COMMUNICATION SYSTEM

(75) Inventors: Xiaohong Yu, Beijing (CN); Xiaoming She, Beijing (CN); Jifeng Li, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., Osaka (JP)

(21) Appl. No.: 12/092,959

(22) PCT Filed: Nov. 24, 2006
(86) PCT No.: PCT/JP2006/323469

§ 371 Date: May 7, 2008

(30) Foreign Application Priority Data
Nov. 24, 2005 (CN) 20051012837.X

(51) Int. Cl. H04B 1/02; H04L 25/49

(52) U.S. Cl. 375/296; 455/101

(57) ABSTRACT

A wireless communication method in which use of the HERQ technique brings about an improved throughput of data transmission. In this method, if the number of retransmissions n is equal or below an upper limit value (ST404: NO), a transmission mode k is computed for k=n mod 4 at the transmission side (ST405), sub-streams are grouped into combinations of sub-streams according to the channel status fed back from the transmission side if k=1 (ST 407), time-space block coding of the data of each group is performed (ST 408), the coded data is allocated to the corresponding antenna and retransmitted (ST409), and the retransmitted data is combined with the previously transmitted data and time-space block decoding is performed (ST410).

### TECHNICAL FIELD

The present invention relates to a radio communication method in a multi-antenna communication system. More particularly, the present invention relates to a radio communication method which is applied to a MIMO (Multi Input/Multi Output) system and which improves data transmission throughput.

### BACKGROUND ART

Many new techniques and new applications such as OFDM and MIMO are introduced in mobile communication in recent years. These new techniques drastically improve the mobile communication system performance and meet demands for radio multimedia and high-speed data transmission.

The MIMO technique is a significant breakthrough in a smart antenna technique in the mobile communication field. The MIMO technique refers to a technique realizing both data transmission and reception using a plurality of antennas. By using the MIMO technique, it is possible to improve channel capacities and channel reliability, and reduce bit error rates. A maximum capacity or an upper limit capacity in a MIMO system increases in proportion to the increase in the number of antennas. Furthermore, by adopting a smart antenna system using multi-antenna or array antenna on a receiving side or transmitting side, the capacity increases in proportion to the increase in the logarithm of the number of antennas. The MIMO technique has extremely significant potential with respect to an increase in the radio communication system capacity and is a key technique applicable to the new-generation mobile communication system.

The MIMO system is used to improve transmission rates. On the other hand, the MIMO system can improve reliability of a communication system by increasing information redundancy while maintaining transmission rates. The former belongs to the category of studies on space-time multiplexing and the latter belongs to the category of studies on space-time encoding.

The space-time multiplexing is directed to maximizing the transmission rate in the MIMO system, and transmits code sequences of different pieces of information through different antennas. On the other hand, in order to cancel influences of fading and noise interference of radio channels on the performance, space-time encoding is directed to receiving the original information at the receiving side correctly by providing a certain relationship to information included in codes transmitted through different antennas. The space-time multiplexing technique includes layered space-time encoding and the like, and the space-time encoding technique includes space-time block encoding and space-time trellis encoding and the like.

There is a high data traffic requirement for the transmission error rate and, for example, a frame error rate is 0.1%. Achieving such high performance in a poor radio channel environment requires the use of channel encoding and an error correction technique. The common technique currently used is a hybrid automatic repeat request (HARQ) technique. This technique combines an automatic repeat request (ARQ) and a forward error correcting (FEC) technique and carries out error detection and error correction. Three types of HARQ are currently available. With type 1 HARQ, the receiving side discards a packet that has not been received correctly and reports the transmitting side through a reverse channel to retransmit a copy of the original packet and decodes a newly received packet independently. With type 2 HARQ, the receiving side does not discard a packet containing an error, combines the packet containing an error with a retransmitted packet and carries out decoding. With type 3 HARQ, a retransmitted packet includes all information necessary to receive data correctly.

When carrying out error correction using HARQ, the transmitting side transmits encoded information to the receiving side first, and the receiving side receives the information and then carries out error correcting decoding on the information. If the data is received correctly, the receiving side transmits an ACK (Acknowledgement) to the transmitting side. On the other hand, if the receiving side cannot carry out error correction, the receiving side transmits a NACK (Negative Acknowledgement) to the transmitting side, requests the transmitting side to retransmit the data and carries out decoding based on retransmitted data which will be received later.

### DISCLOSURE OF INVENTION

### Problems to be Solved by the Invention

When improving transmission reliability using a HARQ technique in the MIMO system, there is a strong demand for throughput improvement.

It is therefore an object of the present invention to provide a radio communication method of improving data transmission throughput when using a HARQ technique in a multi-antenna communication system. This method is especially suitable for use in a MIMO system.

### Means for Solving the Problem

In order to attain the above described object, the radio communication method according to the present invention includes: grouping a plurality of antennas into a plurality of groups according to a retransmission request from a receiving side based on a channel condition; carrying out space-time encoding on data for each of the plurality of groups; and retransmitting the encoded data through the plurality of antennas to the receiving side.

Furthermore, preferably, according to the above described radio communication method, the transmitting side changes the order of data according to another retransmission request from the receiving side based on the channel condition.

Further, preferably, the number of retransmissions is limited to a preset maximum number. Furthermore, preferably, in the grouping of the plurality of antennas, the number of antennas of each group is determined according to a space-time encoding scheme.

Furthermore, preferably, the space-time encoding is space-time block encoding or space-time trellis encoding.

Furthermore, preferably, in grouping of the plurality of antennas, an antenna having a maximum SNR is combined with an antenna having a minimum SNR, and an antenna having the second highest SNR is combined with an antenna having the second lowest SNR.

Furthermore, preferably, the channel condition includes an SNR value of the channel or a Doppler shift.

Furthermore, preferably, the order of data is changed so that data having the worst reception performance is transmitted through the antenna having the maximum SNR and data having the second worst reception performance is transmitted through the antenna having the second highest SNR.

Preferably, the receiving side combines the space-time decoding result with the previous space-time decoding result.

Preferably, the receiving side combines the space-time decoding result with the previous received data.

### ADVANTAGEOUS EFFECT OF THE INVENTION

According to the present invention, it is possible to increase data transmission throughput when improving the reliability of transmission using a HARQ technique in a multi-antenna communication system.

### BRIEF DESCRIPTION OF DRAWINGS

FIG. 1A shows the configuration of a radio communication apparatus in a single data detection mode;

FIG. 1B shows the configuration of the radio communication apparatus in a multi-data detection mode;

FIG. 1C illustrates vertical layered space-time encoding;

FIG. 1D illustrates horizontal layered space-time encoding;

FIG. 2 shows the configuration of a space-time block encoding system;

FIG. 3A shows the configuration of a radio communication apparatus according to Embodiment 1 of the present invention;

FIG. 3B shows the configuration of the retransmission data processing section according to Embodiment 1 of the present invention;

FIG. 4 is an operation flowchart according to Embodiment 1 of the present invention;

FIG. 5A shows the configuration of a radio communication apparatus according to Embodiment 2 of the present invention;

FIG. 5B shows the configuration of the retransmission data processing section according to Embodiment 2 of the present invention; and

FIG. 6 is an operation flowchart according to Embodiment 2 of the present invention.

### BEST MODE FOR CARRYING OUT THE INVENTION

Hereinafter, the principle of the present invention will be explained.

In a MIMO system, a plurality of types of transmission schemes can be combined. For example, two transmission schemes of BLAST (Bell Laboratories Layered Space-Time) and STBC (space-time block code) can be combined.

Furthermore, there are two methods of combining the MIMO system with ARQ. The first method is a single data detection mode, that is, a method of carrying out CRC encoding uniformly on data of respective antennas and retransmitting data of all antennas upon retransmission. The second method is a multi-data detection mode, that is, a method of carrying out CRC encoding individually on data of respective antennas, and, if there is an error in data of any of the antennas, retransmitting only data of the corresponding antenna upon retransmission. By using the multi-data detection mode, it is possible to reduce the amount of retransmission data and improve transmission efficiency. Hereinafter, the present invention will be explained based on these two detection modes.

(1) Single Data Detection Mode

BLAST is used upon initial data transmission and STBC is used upon data retransmission.

Upon the first data retransmission, data of all antennas need to be retransmitted. In this case, the transmitting side groups the plurality of antennas into a plurality of groups based on the channel condition so that one set of antennas is included in each group. When the antennas are grouped, antennas in a good channel condition are combined with antennas in a poor channel condition. For example, antennas of a channel having the maximum SNR value are combined with antennas of a channel having the minimum SNR value. The number of substreams of each group is determined according to the adopted space-time encoding scheme. The space-time encoding scheme includes space-time block encoding and space-time trellis encoding. When, for example, Alamouti space-time encoding is adopted, sets of two antennas are each grouped. Data of antennas in each group are space-time encoded, and part of content of space-time encoded data is transmitted. The receiving side carries out space-time decoding using initial transmission data and retransmission data.

If the receiving side cannot receive data correctly even after the first retransmission, the transmitting side carries out the second retransmission. In this case, the transmitting side selects an antenna for data transmission based on the channel condition, arranges a substream, which is arranged in a channel in a good condition upon the initial transmission, in a channel in a poor condition upon the second retransmission and transmits the substream, and furthermore arranges a substream, which is arranged in a channel in a poor condition upon the initial transmission, in a channel in a good condition upon the second retransmission and transmits the substream. The receiving side combines the data transmitted this time with the data previously obtained through space-time decoding.

If the receiving side cannot still obtain the correct result, the transmitting side groups antennas again upon the third retransmission. Grouping is carried out in order of substreams transmitted last time. However, the order of substreams transmitted last time is already different from the original order of substreams. Furthermore, antennas are grouped based on the channel condition. That is, antennas in the best channel condition are combined with antennas in the worst channel condition, and antennas in the second best channel condition are combined with antennas in the second worst channel condition. Data of antennas in each group is space-time coded, and part of content of space-time encoded data is transmitted. The receiving side carries out space-time decoding on the data transmitted this time and the data transmitted last time, and combines the result of space-time decoding this time with the result of space-time decoding last time. If data is received correctly by retransmission this time, retransmission is finished. On the other hand, if data is not received correctly by retransmission this time, the above described transmission process is repeated until data is received correctly or the number of retransmissions exceeds a preset maximum number of retransmissions (upper limit value).

Taking space-time encoding by STBC using four transmission antennas as an example, the following table shows a case where data is transmitted four times.

TABLE 1

Number of transmissions

| Transmission | First | Second | Third | Fourth |
|---|---|---|---|---|
| antenna | time | time | time | time |
| #1 | S1 | −S4* | S2 | −S1* |
| #2 | S2 | −S3* | S4 | −S3* |
| #3 | S3 | S2* | S1 | S2* |
| #4 | S4 | S1* | S3 | S4* |

Data transmitted from four antennas #1, #2, #3 and #4 upon the first transmission (initial transmission) are S1, S2, S3 and S4, respectively.

If there is an error in data, antennas are grouped based on the channel condition upon retransmission. STBC encoding is adopted, and so each group includes two antennas respectively. Suppose the descending order of SNR values fed back from the receiving side is: antennas #4, #2, #3 and #1. According to the rule that antennas in a good channel condition are combined with antennas in a poor channel condition, antennas #1 to #4 are grouped into two groups, antenna #1 and antenna #4 belong to one group and antenna #3 and antenna #2 belong to the other group. Data in each group is then STBC-encoded. Therefore, for example, encoded data of antenna #1 and antenna #4 are expressed by equation 1 and encoded data of antenna #3 and antenna #2 are expressed by equation 2.

$$\begin{matrix}( Equation 1 ) & \\ [ \begin{matrix}- S {4}^{*} & S 1 \\ S {1}^{*} & S 4\end{matrix} ] & [ 1 ] \\ ( Equation 2 ) & \\ [ \begin{matrix}- S {3}^{*} & S 2 \\ S {2}^{*} & S 3\end{matrix} ] & [ 2 ]\end{matrix}$$

Part of space-time encoded data is transmitted upon the first retransmission. That is, antennas #1 to #4 transmit −S4*, −S3*, S2* and S1*, respectively. On the other hand, the receiving side carries out space-time block decoding using the data received upon the initial transmission and the data received upon the first retransmission. If data is not correctly received on the receiving side even after the first retransmission, the transmitting side rearranges data based on the channel condition upon the second retransmission. In this case, suppose the descending order of SNR values of the channel is: antennas #3, #4, #1 and #2. Substreams are rearranged according to the rule that data in the channel in the best condition upon the initial transmission is arranged and transmitted in the channel in the worst condition upon the transmission this time (second retransmission). Therefore, data transmitted through antennas #1 to #4 are S2, S4, S1 and S3, respectively. The receiving side obtains received data by combining content received through the second retransmission with space-time decoded content obtained after the first retransmission.

If the received data obtained through the second retransmission still contains errors, the third retransmission is carried out.

Upon the third retransmission, antennas are grouped based on the channel condition in the same way as the first retransmission. However, grouping this time is carried out based on the order of the substreams transmitted last time. Furthermore, the order of the substreams transmitted last time is already different from the order of the original substreams. Suppose the descending order of SNR values of the channel this time is: antennas #3, #4, #2 and #1. According to the rule that antennas in a good channel condition are combined with antennas in a poor channel condition, antennas #1 to #4 are grouped into two groups, antenna #1 and antenna #3 belong to one group and antenna #4 and antenna #2 belong to the other group. Space-time encoding is carried out and part of encoded data is transmitted in the same way as the first retransmission. That is, antennas #1 to #4 transmit −S1*, −S3*, S2* and S4*, respectively. The receiving side combines the data received upon the second retransmission with the data received upon the third retransmission, carries out space-time decoding, combines the data after decoding with the space-time decoded data obtained after the first retransmission and thereby obtains the final result.

(2) Multi-Data Detection Mode

Upon the initial data transmission, the original data is S/P-converted to a plurality of parallel substreams. Each substream is individually CRC-encoded, channel encoded, modulated and layered space-time encoded, and then transmitted.

If data of any one antenna is received with an error, the transmitting side may only retransmit data containing the error. Therefore, if there is an error in data of a certain antenna, the transmitting side selects an antenna in the optimum channel condition based on channel information fed back from the receiving side, retransmits original data from the selected antenna, and, on the other hand, transmits new data from the other antennas. The receiving side combines the retransmitted data with the original data and carries out decoding.

Furthermore, if data of two antennas are received with errors, the transmitting side carries out space-time block encoding on the data of these two antennas, transmits the encoded data from the corresponding antennas and transmits new data from the other antennas. The receiving side combines the two received substreams with the original data and carries out space-time decoding.

If data of more than two antennas are received with errors, the transmitting side groups antennas based on the channel condition upon data retransmission in the same way as the single data detection mode. The number of antennas of each group is determined according to the adopted space-time encoding scheme. The transmitting side carries out space-time encoding on data of each group and transmits the encoded data from the corresponding antennas, respectively. The receiving side combines the retransmitted data with the original data and carries out space-time decoding.

If data of a certain antenna is not received correctly even after one retransmission, it is possible to combine results of decoding data of the respective retransmissions upon subsequent retransmissions. For example, after the second retransmission, the second space-time decoding result can be combined with the first space-time decoding result. If the third retransmission is carried out, the third space-time decoding result is combined with the two preceding space-time decoding results.

For example, suppose errors occur in data s1 of antenna #1 and data s4 of antenna #4 out of the four antennas of antennas #1 to #4 upon the first transmission (initial transmission). In this case, the transmitting side must retransmit data of these two antennas. Therefore, the transmitting side carries out space-time block encoding on data s1 of antenna #1 and data s4 of antenna #4 upon retransmission and transmits new data from antenna #2 and antenna #3. However, antenna #1 and antenna #2 need not be grouped here. The result of encoding s1 and S4 is expressed by equation 3, and −s4* and s1* are arranged in antenna #1 and antenna #4, respectively, and transmitted.

$$\begin{matrix}( Equation 3 ) & \\ [ \begin{matrix}s 1 & - s {4}^{*} \\ s 4 & s {1}^{*}\end{matrix} ] & [ 3 ]\end{matrix}$$

After receiving the data retransmitted from these two antennas, the receiving side combines the received data with the original data and carries out space-time block decoding. If the receiving side can receive data of all four antennas correctly, the receiving side reports information (ACK) showing that the data has been received correctly, to the transmitting side, and the transmitting side transmits new data. On the other hand, if the receiving side has not received some of data of the four antennas correctly, the receiving side reports a NACK to the transmitting side, and the transmitting side continues retransmitting data based on the above described process. The receiving side can combine and decode data retransmitted a plurality of times.

The present invention carries out the following processing in a single data detection mode.

1. Upon the first retransmission, the transmitting side groups antennas based on a channel condition (e.g., SNR value of the channel) and carries out space-time encoding on antennas of each group. The number of antennas of each group is determined according to the space-time encoding scheme. The receiving side carries out space-time decoding matching the space-time encoding on the transmitting side, and can thereby obtain spatial diversity and time diversity.

2. A rule of combining antennas in a good channel condition with antennas in a poor channel condition into one group is used as the grouping rule. This allows a channel in a poor condition to be compensated by a channel in a good condition and allows gains of the respective channels to be equalized.

3. Upon the second retransmission, the transmitting side changes the order of substreams based on the channel condition. The transmitting side arranges a substream, which is arranged in a channel in a good condition upon the initial transmission, in a channel in a poor condition upon the second retransmission and transmits the substream, and arranges a substream, which is arranged in a channel in a poor condition upon the initial transmission, in a channel in a good condition upon the second retransmission and transmits the substream. The receiving side combines the data transmitted this time with the space-time decoding result obtained through two preceding transmissions and thereby obtains final data.

4. Upon the third retransmission, in the same way as the first retransmission, the transmitting side groups antennas based on the channel condition, carries out space-time encoding per group and transmits part of the space-time encoded data. The receiving side carries out space-time decoding on the data received this time and data received last time, combines the decoding result with the result of space-time decoding last time and obtains final data.

Furthermore, the following processing is carried out in a multi-data detection mode.

5. If errors occur in data of two antennas, the transmitting side carries out space-time encoding on the data of these two antennas and retransmits the encoded data. This allows time diversity and spatial diversity to be obtained.

6. If there are errors in data of more than two antennas, the transmitting side groups these antennas based on the channel condition, carries out space-time encoding on data of each group and retransmits the encoded data.

Hereinafter, preferred embodiments of the present invention will be explained in detail with reference to the attached drawings.

First, layered space-time encoding (BLAST) will be explained. The basic principle of layered space-time encoding is based on spatial multiplexing. For layered space-time encoding, there are two ARQ methods.

The first ARQ method is a single data detection mode. In the single data detection mode, CRC encoding is carried out before S/P conversion and CRC-encoded data is S/P-converted to data streams. In the single data detection mode, data of all antennas, that is, all packets need to be retransmitted upon retransmission.

The second ARQ method is a multi-data detection mode. In the multi-data detection mode, parallel substreams are formed through S/P conversion and each substream is then CRC-encoded individually. According to the multi-data detection mode, it is possible to reduce the amount of data upon retransmission and improve data transmission efficiency.

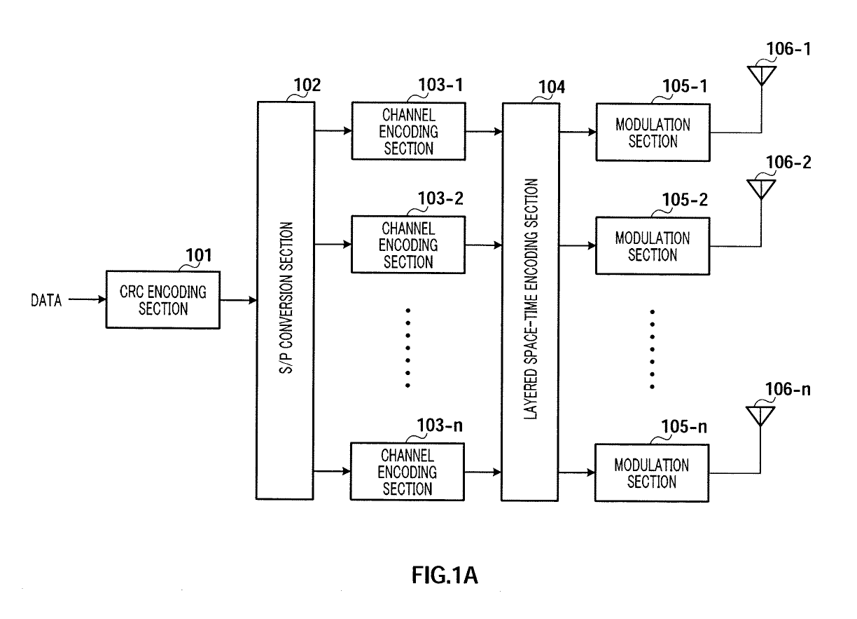

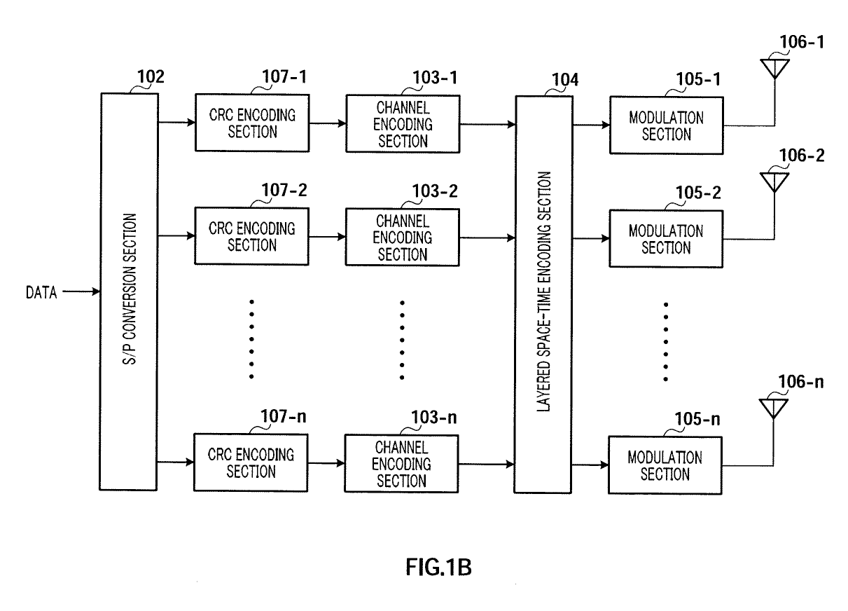

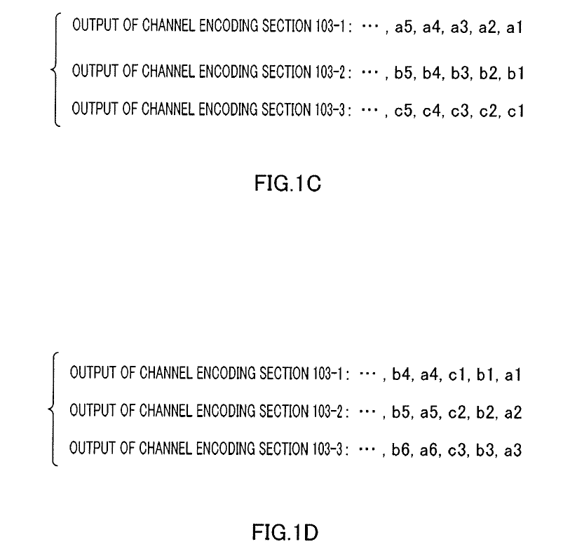

FIG. 1A shows the configuration of a radio communication apparatus in the single data detection mode.

In FIG. 1A, CRC encoding section 101 carries out CRC encoding on inputted data.

S/P conversion section 102 S/P-converts CRC-encoded serial data to parallel data streams (substreams).

Channel encoding sections 103-1 to 103-n carry out channel encoding on their respective substreams individually.

The substreams after channel encoding are layered space-time encoded by layered space-time encoding section 104 according to a predetermined rule, modulated by modulation sections 105-1 to 105-n and transmitted from antennas 106-1 to 106-n.

There is no direct conversion relationship between codes transmitted from different transmission antennas, and so the radio communication apparatus shown in FIG. 1A is not based on transmission diversity.

FIG. 1B shows the configuration of the radio communication apparatus in the multi-data detection mode. In FIG. 1B, the same components as in FIG. 1A will be assigned the same reference numerals.

As shown in FIG. 1B, the multi-data detection mode is different from the single data detection mode (FIG. 1A) in that data is S/P-converted to form parallel substreams by S/P conversion section 102 and then is CRC-encoded by CRC encoding sections 107-1 to 107-n. According to the multi-data detection mode, it is possible to reduce the amount of data upon retransmission and improve data transmission efficiency.

Depending on the difference in the branching scheme on the transmitting side, there are three types of layered space-time encoding scheme including; vertical layered space-time encoding; horizontal layered space-time encoding; and diagonal layered space-time encoding. Here, the vertical layered space-time encoding and horizontal layered space-time encoding will be explained taking a case of M=3 as an example. Suppose the output sequence of channel encoding section 103-1 is a1, a2, a3, a4, . . . , the output sequence of channel encoding section 103-2 is b1, b2, b3, b4, . . . , and the output sequence of channel encoding section 103-3 is c1, c2, c3, c4, . . . . In vertical layered space-time encoding, parallel outputs of channel encoding sections 103-1 to 103-n are space-time encoded in the vertical direction. That is, M symbols outputted from channel encoding section 103-1 are arranged in the first column, M symbols outputted from channel encoding section 103-2 are arranged in the second column and M symbols outputted from channel encoding section 103-3 are arranged in the third column, and the same applies subsequently. As shown in FIG. 1C, encoded symbols are transmitted simultaneously from M antennas per column.

On the other hand, in horizontal layered space-time encoding, parallel outputs of channel encoding sections 103-1 to 103-n are space-time encoded in the horizontal direction as shown in FIG. 1D.

In diagonal layered space-time encoding, parallel outputs of channel encoding sections 103-1 to 103-n are space-time encoded diagonally.

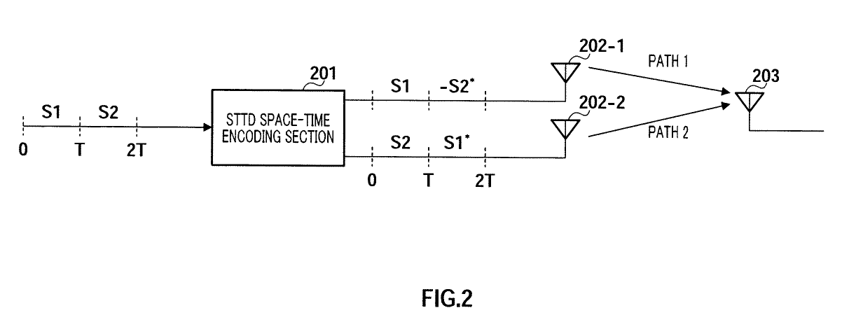

FIG. 2 shows the configuration of a space-time block encoding system. FIG. 2 shows the configuration of the space-time block encoding system using two transmission antennas and one receiving antenna.

Data S1 and S2 are space-time encoded by STTD space-time encoding section 201. Antenna 202-1 transmits S1 and antenna 202-2 transmits S2 within the first code period (0 to T), and antenna 202-1 transmits −S2* and antenna 202-2 transmits S1* within the second code period (T to 2T). Furthermore, S1 and −S2* are received by receiving antenna 203 through path 1, and S2 and S1* are received by receiving antenna 203 through path 2. Space-time encoding enables transmission of information of original codes at different times from different antennas, so that it is possible to obtain spatial diversity and improve transmission efficiency of data.

### EMBODIMENT 1

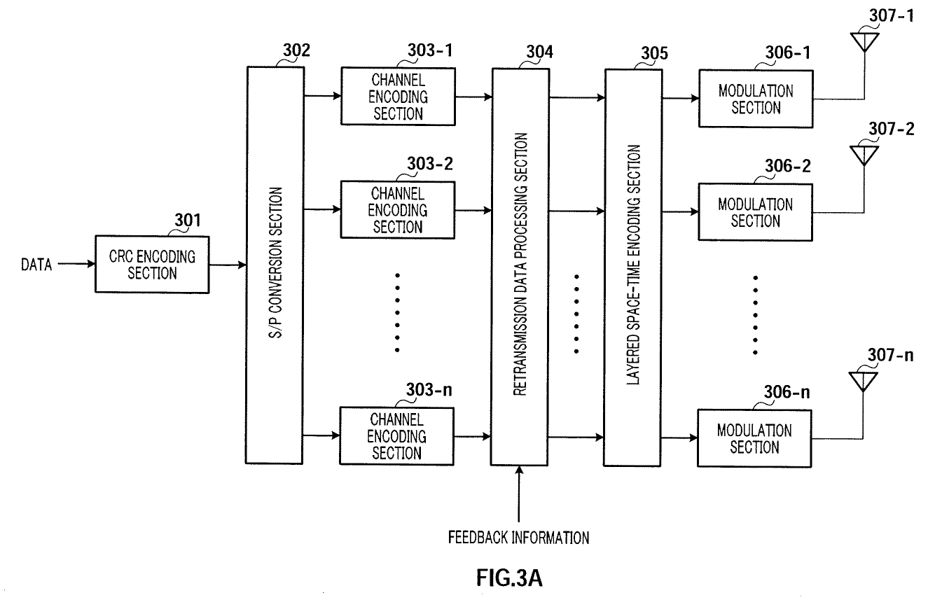

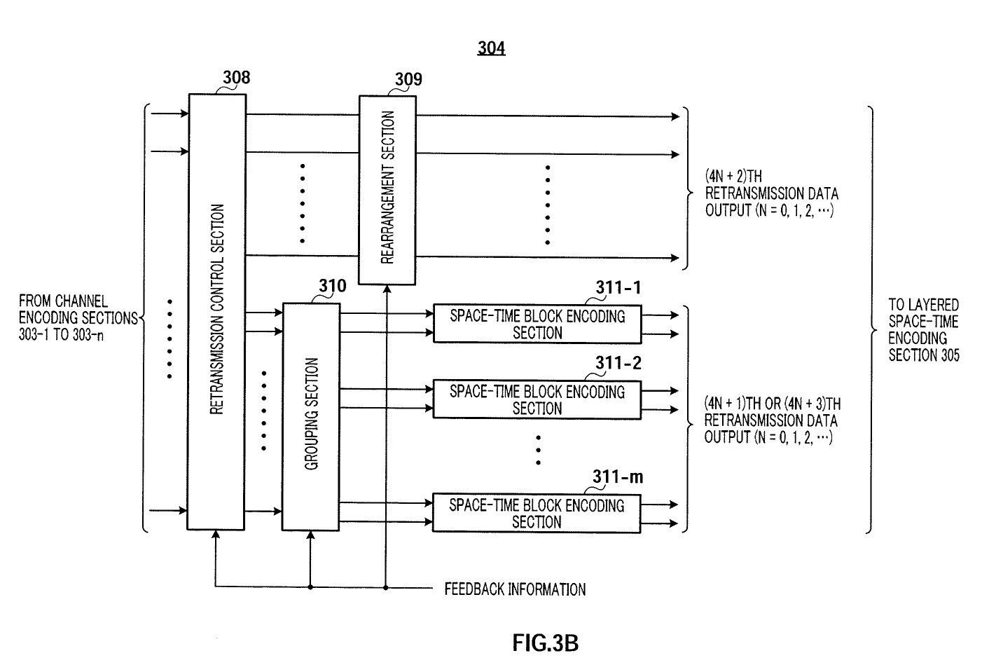

FIG. 3A shows the configuration of a radio communication apparatus on the transmitting side according to Embodiment 1 of the present invention. FIG. 3A shows the configuration when a single data detection mode is adopted. When the single data detection mode is adopted, data of all antennas need to be transmitted upon retransmission.

In FIG. 3A, CRC encoding section 301 carries out CRC encoding on inputted data.

S/P conversion section 302 S/P-converts CRC-encoded serial data to parallel data streams (substreams).

Channel encoding sections 303-1 to 303-n carry out channel encoding on respective substreams individually.

Upon the initial transmission of data, retransmission data processing section 304 carries out no processing, and substreams after channel encoding are directly inputted to layered space-time encoding section 305, respectively.

Layered space-time encoding section 305 carries out layered space-time encoding on the substreams after channel encoding, according to a predetermined rule and assigns data after layered space-time encoding to antennas 307-1 to 307-n. The layered space-time encoding used in this embodiment is horizontal layered space-time encoding.

The data after layered space-time encoding is modulated by modulation sections 306-1 to 306-n and transmitted from antennas 307-1 to 307-n. If the received data contains errors, the receiving side transmits feedback information (NACK) to the transmitting side, and the transmitting side retransmits data of all substreams. FIG. 3B shows the configuration of retransmission data processing section 304.

In retransmission data processing section 304 shown in FIG. 3B, retransmission control section 308 outputs the respective substreams inputted from channel encoding sections 303-1 to 303-n to one of rearrangement section 309 and grouping section 310 based on the number of retransmissions. Substreams are inputted to grouping section 310 upon the first or third retransmission, and substreams are inputted to rearrangement section 309 upon the second retransmission.

Grouping section 310 combines the respective substreams based on the channel condition fed back from the receiving side to group the substreams into a plurality of groups. In this case, channel gains are equalized by combining channels in a good condition with channels in a poor condition.

Space-time block encoding sections 311-1 to 311-m carry out space-time block encoding. For example, when grouping section 310 combines first substream s1 with fifth substream s5 based on the channel condition and outputs s1 and s5 to space-time block encoding section 311-1, data after encoding at space-time block encoding section 311-1 is as expressed by equation 4. −s5* and s1* are assigned to the first antenna and fifth antenna, respectively, and transmitted from the first antenna and the fifth antenna, respectively.

$$\begin{matrix}( Equation 4 ) & \\ [ \begin{matrix}s 1 & - s {5}^{*} \\ s 5 & s {1}^{*}\end{matrix} ] & [ 4 ]\end{matrix}$$

Substreams of the other groups are also space-time block encoded, then assigned to the corresponding antennas and transmitted.

The receiving side combines the data retransmitted this time with the data transmitted last time and carries out space-time block decoding.

If the decoding result is not correct even after the first retransmission, the second retransmission is carried out. Upon the second retransmission, retransmission control section 308 outputs substreams to rearrangement section 309. Rearrangement section 309 rearranges retransmission data based on the fed back channel condition and thereby newly assigns transmission antennas to the retransmission data. In this case, rearrangement section 309 carries out rearrangement such that a substream arranged in a channel in a poor condition upon the initial transmission is arranged in a channel in a good condition this time and a substream arranged in a channel in a good condition upon the initial transmission is arranged in a channel in a poor condition this time. The receiving side combines the received data with the data after space-time block decoding last time.

If data has not been received correctly even after the second retransmission, the third retransmission is carried out. Upon the third retransmission, retransmission control section 308 outputs substreams to grouping section 310 in the order of the second retransmission. Grouping section 310 groups the substreams based on the channel condition fed back from the receiving side and combines a substream of a channel in a good condition with a substream of a channel in a poor condition. When, for example, grouping section 310 combines first substream s1 with third substream s3 and outputs s1 and s3 to space-time block encoding section 311-1, the data after encoding at space-time block encoding section 311-1 is as expressed by equation 5. −s3* and s1* are assigned to the first antenna and the third antenna and transmitted from the first antenna and the third antenna, respectively.

$$\begin{matrix}( Equation 5 ) & \\ [ \begin{matrix}s 1 & - s {3}^{*} \\ s 3 & s {1}^{*}\end{matrix} ] & [ 5 ]\end{matrix}$$

Substreams of the other groups are space-time block encoded and then assigned to their corresponding antennas, respectively, and transmitted.

The receiving side combines the data transmitted this time with the data transmitted last time, carries out space-time block decoding and combines the decoding result with the result of space-time decoding last time. If correct data has not still been obtained even after the third retransmission, the above described process is repeated until data is received correctly or the number of retransmissions reaches a predetermined upper limit number.

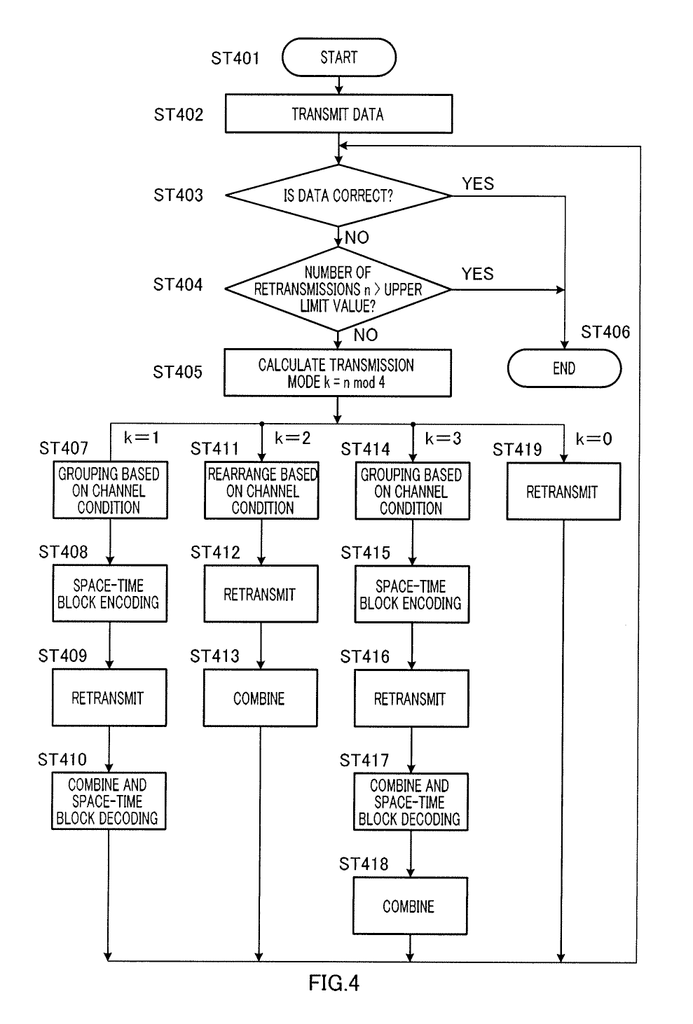

FIG. 4 is an operation flowchart according to Embodiment 1 of the present invention.

After the system is started (ST401), the transmitting side transmits data (ST402).

If the data received on the receiving side is correct (ST403: YES), this flow is finished (ST406). On the other hand, if there is an error in the received data (ST403: NO), it is decided whether or not the number of retransmissions n has exceeded the upper limit value (ST404).

If the number of retransmissions n has exceeded the upper limit value (ST404: YES), no retransmission is carried out and this flow is finished (ST406). On the other hand, if the number of retransmissions n has not exceeded the upper limit value (ST404: NO), transmission mode k is calculated according to k=n mod 4 (ST405).

If k=1, the transmitting side combines the respective substreams based on the channel condition fed back from the receiving side to group the substreams (ST407). In this case, channel gains are equalized by combining channels in a good condition with channels in a poor condition.

Next, data of each group is space-time block encoded (ST408), the encoded data is assigned to the corresponding antennas and retransmitted (ST409).

The receiving side then combines the data retransmitted this time with the data transmitted last time and carries out space-time block decoding (ST410).

Next, the receiving side decides whether or not the decoded data is correct (ST403).

If the decoding result is still not correct (ST403: NO), ST404 and ST405 are executed to obtain new k.

k=2, and so the transmitting side rearranges the retransmission data based on the channel condition (ST411). In this case, rearrangement is carried out in such a way that the data stream arranged in a channel in a poor condition upon the initial transmission in ST402 is arranged in a channel in a good condition this time, and the data stream arranged in a channel in a good condition upon the initial transmission in ST402 is arranged in a channel in a poor condition this time.

The rearranged data is then retransmitted (ST412).

The receiving side combines the received data with the data subjected to space-time block decoding last time (ST413).

Next, the receiving side decides whether or not the combined data is correct (ST403).

If the data is not correct (ST403: NO) and the number of retransmissions has not exceeded the upper limit value (ST404), k=3 is obtained (ST405) and the third retransmission is carried out.

The transmitting side carries out grouping based on the channel condition again (ST414), carries out space-time block encoding on the data of each group (ST415) and retransmits the encoded data (ST416).

The receiving side combines the data transmitted this time with the data transmitted last time, carries out space-time block decoding (ST417), and combines the decoding result with the result of space-time block decoding last time (ST418). If correct data is still not obtained (ST403: NO), the above described flow is repeated until correct data is obtained (ST403: YES) or the number of retransmissions reaches the predetermined upper limit value (ST404: YES).

If k=0, retransmission is carried out in the same way as the initial transmission (ST419).

### EMBODIMENT 2

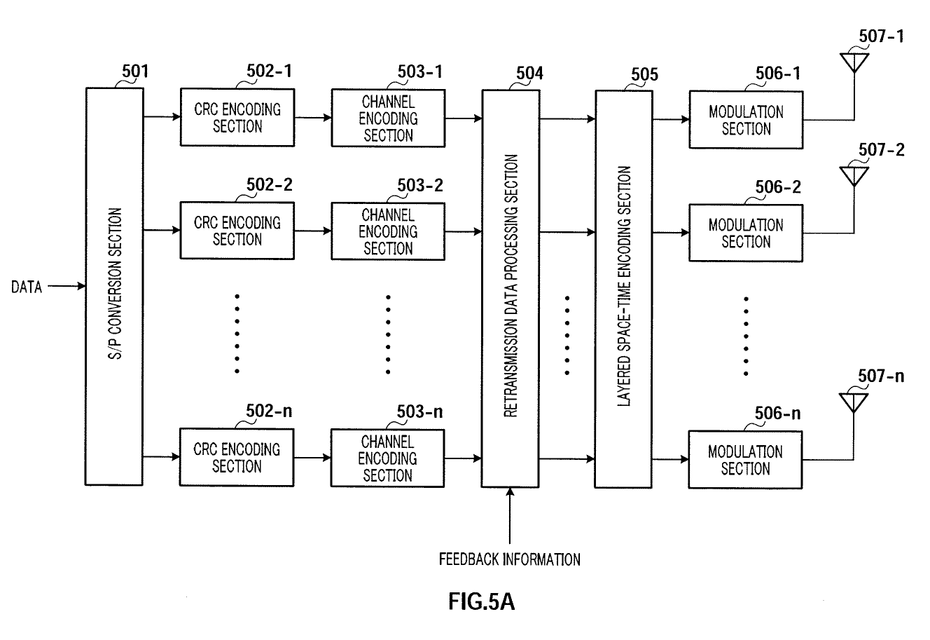

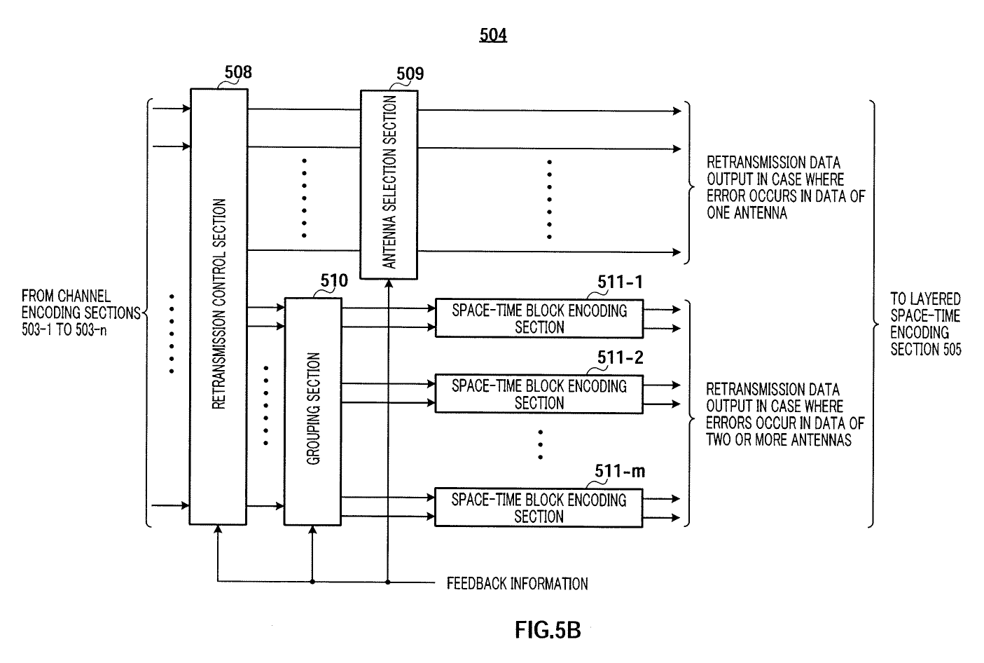

FIG. 5A shows the configuration of a radio communication apparatus on the transmitting side according to Embodiment 2 of the present invention. FIG. 5A shows the configuration when a multi-data detection mode is adopted. In the multi-data detection mode, data of each antenna is CRC-encoded individually, and, if there is an error in data of one antenna, only the data of the one antenna is retransmitted. This allows the amount of retransmission data to be reduced and allows the transmission efficiency to be improved.

In FIG. 5A, data is S/P-converted to a plurality of parallel substreams by S/P conversion section 501.

The respective substreams are individually CRC-encoded by CRC encoding sections 502-1 to 502-n and channel-encoded by channel encoding sections 503-1 to 503-n.

If errors are detected from data of several antennas on the receiving side, the data is inputted to retransmission data processing section 504 upon retransmission. FIG. 5B shows the configuration of retransmission data processing section 504.

If there is an error in data of one antenna, retransmission control section 508 outputs substreams to antenna selection section 509.

Antenna selection section 509 selects an antenna in the optimum channel condition based on fed back channel information, assigns retransmission data to the selected antenna and assigns new data to the other antennas.

Furthermore, if there are errors in data of two or more antennas, retransmission control section 508 outputs substreams to grouping section 510.

If there are errors in data of two antennas, the two antennas need not be grouped. Therefore, space-time block encoding sections 511-1 to 511-m directly carry out space-time block encoding on the data of these two antennas and transmit the encoded data from the corresponding antennas. On the other hand, new data is transmitted from the other antennas. Furthermore, grouping and space-time block encoding need not be carried out on the new data.

If errors occur in data of more than two antennas, grouping section 510 carries out grouping based on the channel condition in the same way as the single data detection mode. The number of antennas of each group is determined according to the adopted space-time encoding scheme. Space-time block encoding sections 511-1 to 511-m carry out space-time block encoding on the data of each group, and the encoded data is transmitted from the corresponding antennas. On the other hand, new data is transmitted from antennas with no errors. Grouping and space-time block encoding need not be carried out on this new data. The receiving side combines the retransmitted data with the original data and carries out space-time block decoding.

Layered space-time encoding section 505 carries out layered space-time encoding on the substreams inputted from retransmission data processing section 504 according to a predetermined rule and assigns the data after layered space-time encoding to antennas 507-1 to 507-n. The layered space-time encoding used in this embodiment is horizontal layered space-time encoding. The data after layered space-time encoding is modulated by modulation sections 506-1 to 506-n and transmitted from antennas 507-1 to 507-n.

If errors occur in data of the first antenna and data of the fourth antenna upon the first transmission (initial transmission), the receiving side must feedback retransmission information (NACK) and channel information to the transmitting side, and the transmitting side must retransmit the data of these two antennas. Therefore, retransmission control section 508 outputs substreams to grouping section 510 based on the retransmission information (NACK) fed back from the receiving side. If errors occur in the two antennas, the antennas need not be grouped, and therefore data s1 of antenna #1 and data s4 of antenna #4 are directly inputted to any one of space-time block encoding sections 511-1 to 511-m and space-time block encoded. On the other hand, new data is transmitted from antenna #2 and antenna #3. Furthermore, the new data is not space-time block encoded. The results of space-time block encoding of s1 and s4 are as expressed by equation 6, and −s4* and s1* are arranged in the first antenna and the fourth antenna and retransmitted, respectively.

$$\begin{matrix}( Equation 6 ) & \\ [ \begin{matrix}s 1 & - s {4}^{*} \\ s 4 & s {1}^{*}\end{matrix} ] & [ 6 ]\end{matrix}$$

After receiving the data retransmitted from these two antennas, the receiving side combines the received data with the original data and carries out space-time block decoding. If all items of data of the four antennas have been received correctly, the receiving side transmits information (ACK) that data have been received correctly and the transmitting side transmits new data. On the other hand, if some of the four antennas have not received data correctly, the receiving side transmits NACK and the transmitting side continues retransmitting data according to the above described process.

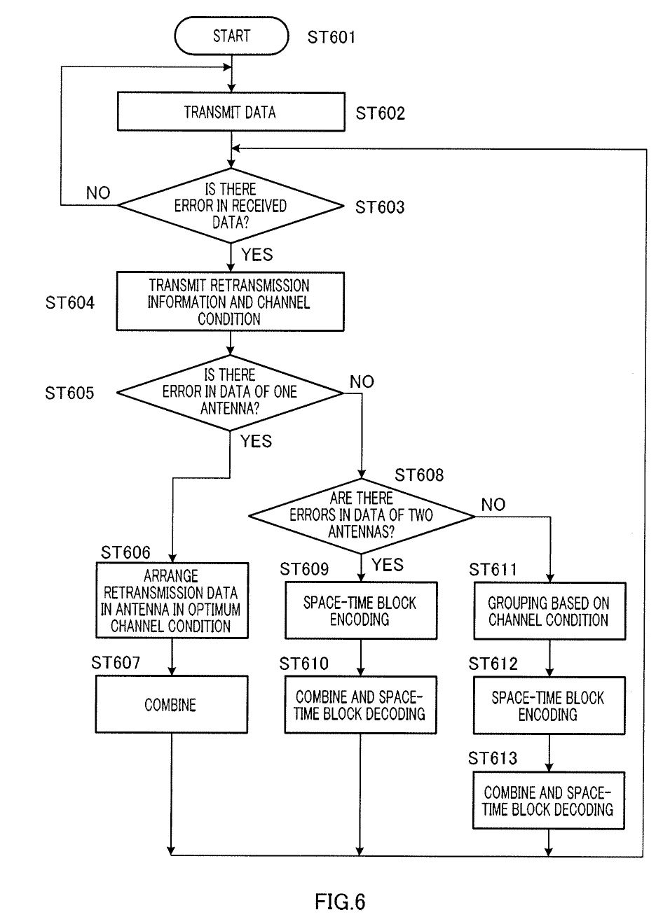

FIG. 6 shows an operation flowchart according to Embodiment 2 of the present invention.

After the flow is started (ST601), the transmitting side transmits data (ST602).

The receiving side decodes received data and decides whether or not there is any error in the received data (ST603).

If no error is detected in the received data (ST603: NO), the receiving side reports the transmitting side so as to transmit new data.

On the other hand, if there are errors in the data of some antennas (ST603: YES), the receiving side transmits retransmission information (NACK) and channel condition to the transmitting side (ST604).

If there is an error in data of one antenna (ST605: YES), the transmitting side selects an antenna in the optimum channel condition based on the fed back channel condition, arranges the retransmission data in the selected antenna and transmits the retransmission data (ST606). New data is transmitted from the other antennas. The receiving side combines the retransmission data with the original data and carries out decoding (ST607).

If there are errors in data of two antennas (ST605: N0, ST608: YES), the transmitting side carries out space-time block encoding on the data of these two antennas and transmits the encoded data from the corresponding antennas (ST609). New data is transmitted from the other antennas.

The receiving side combines the two received substreams with the original data and carries out space-time block decoding (ST610).

If there are errors in data of more than two antennas (ST605: N0, ST608: NO), the transmitting side carries out grouping based on the channel condition when retransmitting the data, in the same way as the single data detection mode (ST611). The number of antennas in each group is determined according to the adopted space-time encoding scheme.

Next, the transmitting side carries out space-time block encoding on the data of each group and transmits the encoded data from the corresponding antennas (ST612).

The receiving side combines the retransmission data with the original data and carries out space-time block decoding (ST613).

The embodiments of the present invention have been explained so far.

The present application is based on Chinese Patent Application No. 200510128637.X, filed on Nov. 24, 2005, the entire disclosed content of the specification, drawings and abstract of which is incorporated herein by reference.

### INDUSTRIAL APPLICABILITY

The present invention provides the effect of improving throughput when carrying out error correction using HARQ in a MIMO system, and is useful as a radio communication method and the like applicable to the MIMO system.

1. A radio communication method comprising:
on a transmitting side of a multi-antenna communication system:
grouping a plurality of antennas into a plurality of groups according to a retransmission request from a receiving side based on a channel condition;
carrying out space-time encoding on data for each of the plurality of groups; and
retransmitting the encoded data through the plurality of antennas to the receiving side.

2. The radio communication method according to claim 1, wherein antennas having a maximum signal-to-noise ratio are combined with antennas having a minimum signal-to-noise ratio in the grouping.

3. The radio communication method according to claim 1, wherein an order of data is changed according to another retransmission request from the receiving side based on a channel condition.

4. The radio communication method according to claim 3, wherein an order of data is changed by assigning data having a minimum signal-to-noise ratio to an antenna having a maximum signal-to-noise ratio.

5. The radio communication method according to claim 1, wherein a number of retransmissions is limited to a preset maximum number.

6. The radio communication method according to claim 1, wherein a number of antennas of each group is determined according to a space-time encoding scheme in the grouping.

7. The radio communication method according to claim 1, wherein the space-time encoding is space-time block encoding or space-time trellis encoding.

8. The radio communication method according to claim 1, wherein the receiving side carries out space-time decoding using initial transmission data and retransmission data.

9. The radio communication method according to claim 8, wherein the receiving side combines a plurality of space-time decoding results.

10. A radio communication apparatus in a multi-antenna communication system, the apparatus comprising:
a grouping section that groups a plurality of antennas into a plurality of groups according to a retransmission request based on a channel condition;
a encoding section that carries out space-time encoding on data for each of the plurality of groups; and
a modulation section that modulates the encoded data and retransmits the encoded data to the receiving side through the plurality of antennas.
